(19) United States
(12) Patent Application Publication
(10) Pub. No.: US 2017/0022931 A1
(43) Pub. Date: Jan. 26, 2017

(54) FLATHEAD ENGINE SHROUD FOR A SMALL BLOCK ENGINE

(71) Applicant: WEBB MOTOR WORKS LTD, Victoria (CA)

(72) Inventor: Chris WEBB, Victoria (CA)

(21) Appl. No.: 15/068,497

(22) Filed: Mar. 11, 2016

Related U.S. Application Data
(60) Provisional application No. 62/195,816, filed on Jul. 23, 2015.

(51) Int. Cl. F02F 7/00

(52) U.S. Cl. CPC F02F 7/0068; F02F 7/0073

(57) ABSTRACT

The present technology provides a kit for shrouding a stock engine to make it appear as a flathead engine, the kit comprising a timing cover casting, a front casting, a pair of exhaust manifold panel castings, a pair of valve cover castings, a pair of support bars, an intake manifold casting, a rear casting, and instructions. Also provided are a method of manufacturing the kit, a method of assembling the kit and a faux flathead engine.

### CROSS REFERENCE TO RELATED APPLICATIONS

This application is related to, and claims the benefit of, U.S. Provisional Patent Application No. 62/195,816, filed 23 Jul. 2015, entitled FLATHEAD ENGINE SHROUD FOR A SMALL BLOCK ENGINE. The above-identified priority patent application is incorporated herein by reference in its entirety.

### FIELD

The present technology relates to a shroud for modifying stock engines such that they have the appearance of a Ford flathead engine. More specifically, the present technology is an easy to use kit for the hot rod enthusiast to use to transform the exterior of a small block engine in a day or afternoon.

### BACKGROUND

The Ford flathead V8 is a flathead V8 engine designed by the Ford Motor Company. It was a staple of hot rodders in the 1950s, and it remains famous in the classic car hobbies even today, despite the huge variety of other popular V8s that followed. These engines, amazing in their time, were plagued with overheating problems and relatively low horsepower for the cubic inch size.

In 1955, General Motors, specifically the Chevrolet division, introduced the small block engine. This design provided increased reliability and horsepower and was fifty pounds lighter. The new design incorporated many features allowing for the inclusion of power windows, air conditioning, power steering and brakes. It had a single water pump that prevented overheating so that the engine could run all day at constant temperature. Another small block engine was made by Ford.

By the 1960's “Hot Rod” enthusiasts began to replace their flathead motors with small block engines primarily due to their reliability and horsepower. Over the next few decades the small block motors became the norm. Now interest in recreating the past has grown so that the flathead engine is once again gaining popularity. It's now very desirable to put a flathead motor into hot rods. Unfortunately, good engine blocks are rare. It is not uncommon to invest time and money on one only to find the engine block is cracked and unusable.

One attempt to retain the advantages of the small block engine, while apparently using a flathead engine is described in U.S. Pat. No. 5,311,847. It discloses a flathead adaption system for an engine that adapts the engine to, in part, look like a 1950's flathead engine. First the existing valve cover is removed from the engine. Thereafter, an adapter member is mounted at a valve cover opening from which the valve cover was removed. A rectangular plate-shaped flathead member is mounted to the top surface of the adapter member covering over the valve cover opening. The flathead member is provided with a plurality of non-energized spark plugs. When one or more of these non-energized spark plugs is removed, the resulting aperture is then used for pouring oil into the engine in place of the oil filling aperture in the valve cover which was removed. This system, while purporting to adapt the engine to look like a flat head engine, actually only replaces the existing valve cover with the “flathead-type” valve cover. The result is not an engine that has the appearance of a flathead engine. Further, the adaptation involves interfering with the integrity of the stock engine.

In a related art, United States Patent Application 20050132997 discloses a customization cover for use with an engine valve cover that has a main body portion configured with one or more design elements thereon to provide an improved visual effect for a vehicle engine and engine compartment. Mounting openings in the main body member are cooperatively configured to receive a connector element to place the customization cover generally above the valve cover. Preferably, side components having side design elements extend downwardly from the main body to from a generally elongated channel that is disposed above the valve cover. The connector elements can connect to the valve cover mounting points or to the ignition coil mounting points. Spacer elements, brackets and/or mounting arms on the side components can be utilized to secure the customization cover in a spaced apart relation to the valve cover to provide an enhanced three dimensional visual effect. This simply adds decorative elements to the engine valve cover and does not shroud the engine. The result is not an engine that has the appearance of a flathead engine.

United States Patent Application 20100269779 discloses a valve cover that includes a base that attaches to an engine and a display window that attaches to the base. The display window is made of material that can withstand the operating environment of the engine, including temperature and resistance to petroleum-based substances. The display window is secured to the base using a flexible gasket that encircles the display window and snaps into a groove in the base to secure the display window to the base. The display window may be see-through so the valves are visible. The display window may also include one or more display elements, such as light-emitting diodes, optical fibers, electro-luminescent panels, incandescent bulbs, liquid crystal displays, etc. The display window may include embossed or etched portions, and may include multiple colors and sequenced operation to provide any desired effect on the display panel. This does not address the problems that flathead engines have. The result is not an engine that has the appearance of a flathead engine.

United States Patent Application 20060070599 discloses an engine cover includes an installation member, a cover body, and an installed member. The installation member is disposed on an engine. One of the installation member and the installed member includes a leg, and a head, and the other one of them includes a framed member, and an elastic member. The elastic member includes a first hole, a second hole, and a diametrically-enlarged intermediate hole. The head engages with the diametrically-enlarged intermediate hole. Moreover, the head is disposed movably toward the second hole when a downward load is applied to the cover body, thereby bringing the cover body closer to the engine. The result is not an engine that has the appearance of a flathead engine.

U.S. Pat. No. 4,149,512 discloses an internal combustion engine having a sound-deadening shroud surrounding the engine block and connected to latter with the interposition of anti-vibration means. An exhaust plant through which combustion gases are connected is arranged external of the shroud and connected to the engine block. A separate enclosure is secured to the shroud and encloses the exhaust plant leaving a small air gap on all sides between the exhaust plant and the enclosure with only the exhaust pipe of the exhaust plant projecting from the enclosure through an opening. The result is not an engine that has the appearance of a flathead engine.

What is needed is a kit and product that provides a shell or shroud for a stock engine that results in it appearing to be a Ford flathead V8, V12 or V16 engine. The kit would preferably be easy to install and would only impact on engine peripherals, such as the distributor, exhaust manifold and water pump. This would not result in oil spillage, nor would there be any concerns about engine gaskets needing to be replaced, nor would there be concerns of a poor seal between the engine parts. It would be best if it could be installed in a matter of hours. An additional advantage would be the capability of producing the shroud for a V12 or V16, by simply extending the side piece molds, whilst using the same molds for the remainder of the parts for production. An engine that mimics the flathead engines would also be desirable.

### SUMMARY

The present technology provides an easy to assemble kit, or the already assembled shroud that provides a shell for a stock engine that results in it appearing to be a Ford flathead V8, V12 or V16 engine. The kit and shroud only impacts on engine peripherals, such as the distributor, exhaust manifold and water pump. Installation should not result in oil spillage, nor should there be any concerns about engine gaskets needing to be replaced, nor should there be concerns of a poor seal between the engine parts. The kit can be assembled and installed in a matter of hours. The shroud can be configured for a V12 or V16, by simply extending the side piece molds for the V8, whilst using the same molds for the remainder of the parts for production. The product is an engine that mimics the flathead engine in exterior appearance.

In one embodiment, a faux engine is provided, the faux engine comprising a stock engine and a shroud for the stock engine, wherein the shroud comprises a plurality of components assembled to provide an interior space to house the stock engine, is attached to the stock engine, and is configured to substantially conceal the stock engine and mimic an exterior of a different engine.

In the faux engine, the different engine is a flathead engine.

In the faux engine, the shroud may be configured to expose a plurality of spark plug sockets on the stock engine, a bottom of the stock engine and a bell housing of the stock engine and to conceal a remainder of the stock engine.

The faux engine may further comprise a plurality of non-operational spark plugs mounted on a valve cover portion of the shroud, a non-operational distributor mounted on a front portion of the shroud and a plurality of non-operational spark plug leads extending therebetween.

The faux engine may further comprise a plurality of operational spark plugs located in the spark plug sockets, a distributor-less ignition and a plurality of operational spark plug leads therebetween.

In the faux engine, the plurality of operational spark plug leads may be routed between the shroud and the stock engine.

The faux engine may further comprise a pair of operational water pumps mounted on and in fluid communication with the front portion of the shroud.

In the faux engine, the stock engine may be a small block engine.

In another embodiment, a flathead shroud for a stock engine is provided, the flathead shroud comprising a plurality of components assembled to provide an interior space, the interior space for housing a small block engine, and an exterior, the exterior configured to mimic an exterior of a flathead engine, and to substantially conceal the stock engine.

In the flathead shroud, the plurality of components may include: an intake manifold casting; a pair of valve cover castings; a rear casting; a pair of exhaust manifold panel castings; and one of either a front casting and a timing cover casting or an integrated timing cover and front casting, the components assembled such that the intake manifold casting is atop the pair of valve cover castings, the pair of exhaust manifold panel castings are below the pair of valve cover castings, the front casting and timing cover casting or the integrated timing cover and front casting abut a front of each of the intake manifold casting, the pair of valve cover castings and the pair of exhaust manifold panel castings, the timing cover casting, if present, is in front of the front casting and the rear casting abuts a rear of each of the intake manifold casting, the pair of valve cover castings and the pair of exhaust manifold panel castings.

In the flathead shroud, the interior space may be sized to additionally house a plurality of spark plug leads, an at least one water hose, and a split diverter.

In the flathead shroud, the intake manifold casting may include an at least one mount for an at least one carburetor and an at least one carburetor port for gaseous communication with the at least one carburetor.

In the flathead shroud, the pair of valve cover castings may include a plurality of non-operational spark plug sockets.

In the flathead shroud, the front casting or integrated timing cover and front casting may include a pair of mounting plates for a pair of water pumps and a channel through the front casing for liquid communication with the pair of water pumps.

In yet another embodiment, a kit for shrouding a stock engine to make it appear as a flathead engine is provided, the kit comprising a timing cover casting, a front casting, a pair of exhaust manifold panel castings, a pair of valve cover castings, a pair of support bars, an intake manifold casting, a rear casting, and instructions.

In the kit, the pair of valve cover castings may include a plurality of non-operational spark plug sockets.

In the kit, the timing cover casting may include a mounting plate for a distributor.

In the kit, the front casting may include a pair of mounting plates for a pair of water pumps and a channel through the front casing for liquid communication with the pair of water pumps.

In the kit, the intake manifold casting may include an at least one mount for an at least one carburetor and an at least one carburetor port for gaseous communication with the at least one carburetor.

The kit may further comprise a pair of support bars.

In yet another embodiment, a kit for shrouding a small block engine to make it appear as a flathead engine is provided, the kit comprising a timing cover casting, a front casting, a pair of exhaust manifold panel castings, a pair of valve cover castings, a pair of support bars, an intake manifold casting, a rear casting, and instructions.

In the kit, the pair of valve cover castings may include a plurality of non-operational spark plug sockets.

### FIGURES

FIG. 1 is a perspective view of the assembled shroud of the present technology.

FIG. 2 is a perspective view of an alternative embodiment.

FIG. 3 is an exploded view of the shroud of the present technology.

FIG. 4 is an exploded view of the support bars, front casting and rear casting of the present technology.

FIG. 5 is a partial cutaway side view of the present technology showing the stock engine inside.

FIG. 6 is a partial cutaway of a top view of the present technology showing the coolant system. The existing block is shown with coolant channel and water pump apertures exposed in the cutaway.

FIG. 7A is a side view of the water intake system.

FIG. 7B is a top view of the split diverter and water intake lines of the present technology.

FIG. 8 is an exploded view of the exhaust system of the present technology.

FIG. 9A is a view of the gear drive of an alternative embodiment.

FIG. 9B is a view of the gear drive of an alternative embodiment.

FIG. 10 is a side view of an alternative embodiment.

FIG. 11 is a partial cutaway top view of an alternative embodiment of the present technology.

FIG. 12 is an exploded view of the front lower cover of the alternative embodiment.

FIG. 13A is a view showing the timing cover and front as a single component.

FIG. 13B shows the front and support bars as a single component.

FIG. 13C shows the timing cover, front and support bars as a single component.

FIG. 13D shows the front, support bars and rear as a single component.

FIG. 13E shows the timing cover, front, support bars and rear as a single component.

FIG. 13F shows the support bars and the rear as a single component.

FIG. 13G shows the intake manifold and valve cover as a single component.

FIG. 13H shows the valve cover and exhaust manifold panel as a single component.

FIG. 14 shows the templates for the molds used to cast the components for a V8.

FIG. 15 shows the templates for the molds used to cast the components for a V12.

### DESCRIPTION

### Definitions

Stock engine: In the context of the present technology, a stock engine is the engine that is used to run the vehicle and is made to look like a flathead engine with the shroud. This could be, for example, but not limited to, a small block Chevrolet engine, a small block Ford engine, a large block Chevrolet engine, a Dodge engine, a large block Ford engine, V-6 engine or V-8 engine.

### DETAILED DESCRIPTION

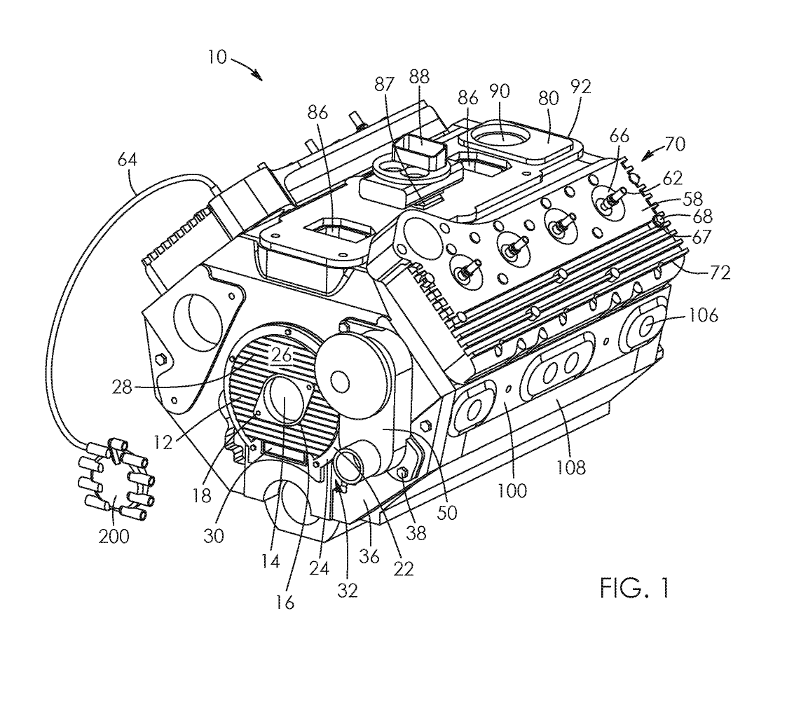

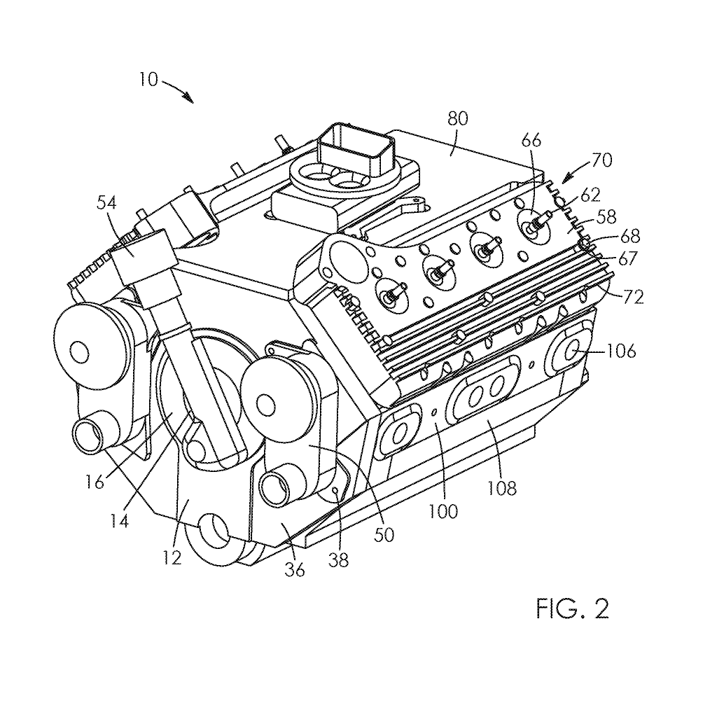

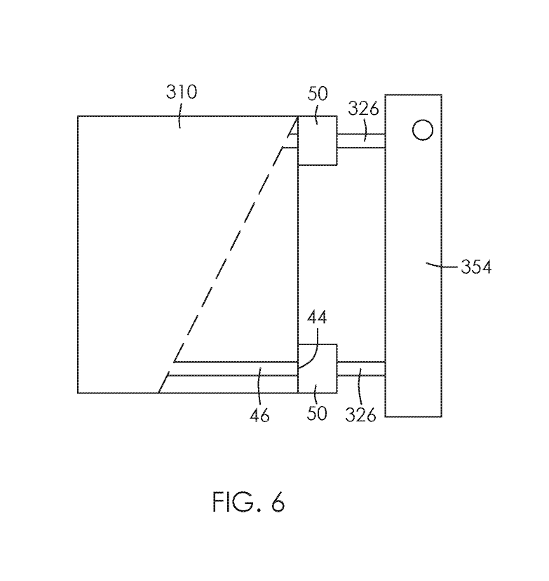

An engine shroud, generally referred to as 10 is shown in FIG. 1. The shroud 10 is comprised of eight sections of cast aluminum that, when assembled, mimics the look of a classic flathead Ford engine. A timing cover casting 12 includes a distributor aperture 14 with a distributor mounting plate 16 surrounding the aperture 14, for mounting either a distributor or a non-operational distributor. Two apertures 18 are located on the distributor mounting plate 16. The shape of the distributor mounting plate 16 can be quite variable depending on the year of engine being mimicked. A rim 22 with five apertures 24 surrounds much of the interior surface 26 of the timing cover casting 12. The exterior surface 26 may or may not have ribs 28. A logo plate 30 is at a lower end, generally referred to as 32, of the timing cover casting 12. The timing cover casting 12 fits snugly into the front casting 36 and is bolted to it with bolts 38. As shown in FIG. 2, the front casting 36 includes two water pump mounting plates 40 each surrounding water pump apertures 44 that are at the front terminus of coolant channels 46 (see FIG. 6 for coolant channels). Returning to FIG. 1, a water pump 50 is shown located on one of the mounting plates 42. It is affixed to the front casting 36 with bolts 38. Exhaust manifold panel mounts 56 are also on the front 42 of the front casting 36.

In an alternative embodiment, shown in FIG. 2, a tubular distributor mount 54 may be mounted on the timing cover casting 12. It extends upward from the shroud 10. This design permits the use of the small block distributor, hence there is no need for a non-operational distributor to be used.

Returning to FIG. 1, a left and right valve cover casting 58 include spark plug sockets 60, which, depending on the size of the engine being emulated, can be four, six or eight sockets 60 per side for four, six or eight spark plugs 62. A non-operational spark plug lead 64 is attached to each non-operational spark plug 62 at one end and to the distributor 200 (non-functioning) at the other end. Each socket 60 is surrounded by a depression 66. A plurality of acorn nuts 68 and washers 67 are located on the valve cover castings 58. Some of these are functional, and others may not be. On the face, generally referred to as 70, there is a pattern of horizontal ribbing 72.

An intake manifold casting 80 is mounted to the front casting 36. It has three dual carburetor ports 86, mounts 87 for the carburetors 88 and an electronic ignition system port 90 at the back end 92 of the intake manifold casting 80. The electronic ignition system port 90 is for mounting an electronic, distributor-less ignition system 94 within. The port 90 has a removable cover 95.

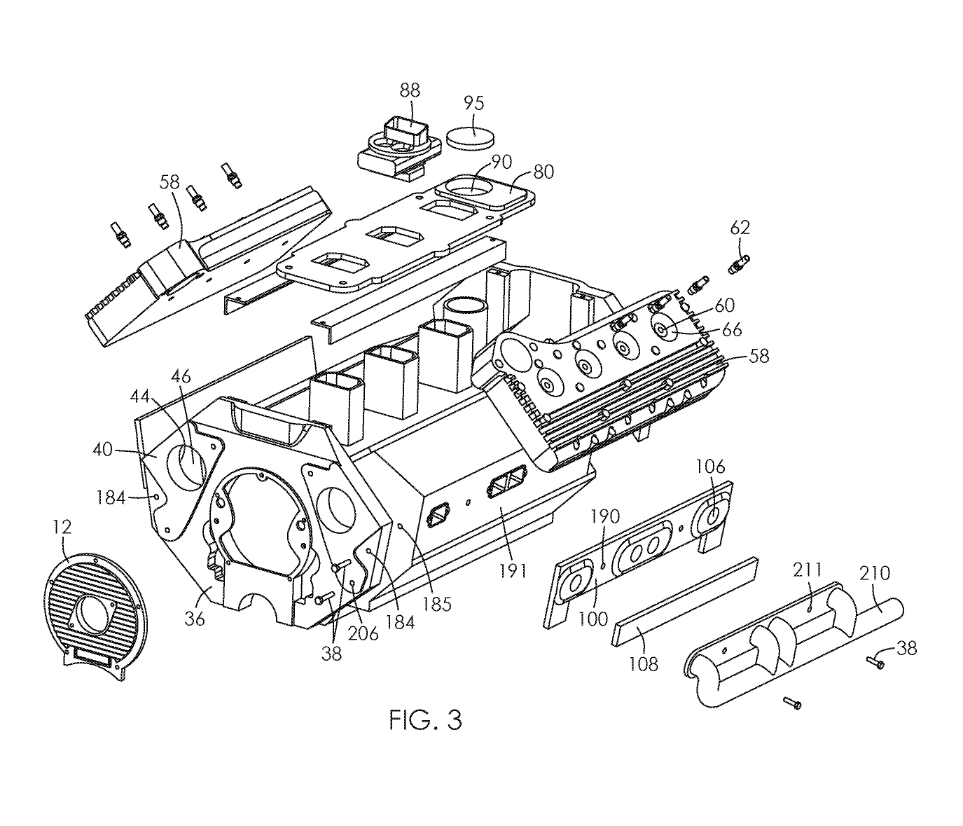

Below the valve cover castings 58 are right and left exhaust manifold panel castings 100. These are mounted on the exhaust manifold panel mounts 56 of the front casting 36 and on the lower section, generally referred to as 102, of the valve cover castings 58. Depending on the design, there may be three or four exhaust ports 106 in the exhaust manifold panel castings 80. These exhaust ports 106 are for gaseous communication with the exhaust manifolds 210 (shown in FIG. 3). The exhaust manifolds 210 are retained by bolts 38 through exhaust manifold apertures 211. A spark plug cover casting 108 is mounted below the exhaust manifold panel castings 100. This is to shroud the spark plugs. It may be a separate casting or integrated into the exhaust manifold panel casting 100.

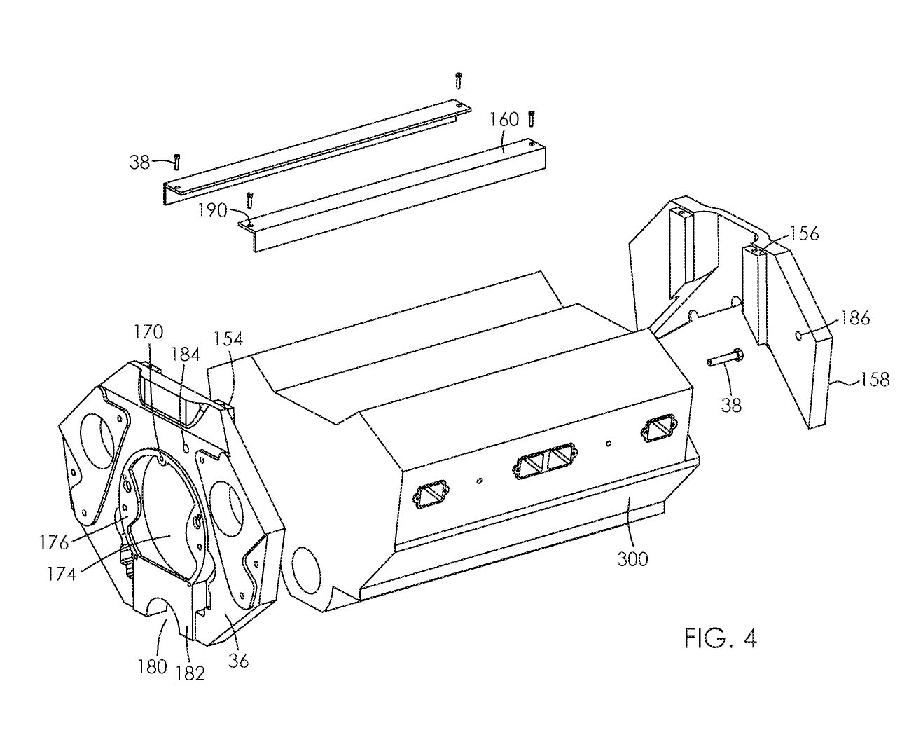

As shown in FIG. 4, a front step 154 and back step 156 on the front casting 36 and rear casting 158, respectively, support a support bar 160 on each side of the head of the existing engine. The support bars 160 support the intake manifold casting 80. The front casting 36 has threaded holes 170 in the front 40 for accepting bolts 38 to retain the timing cover casting 12, and a front aperture 174 with a step 176 to accept the timing cover casting 12. At the lower end, generally referred to as 178, of the front casting 36 there is a semi-circular opening 180 surrounded by a rectangular plate 182. The rear casting 158 is shaped to cover the back of the block and cylinder heads of the existing engine 300. The rear casting 158 allows access to the bell housing bolt holes on the small block engine 300.

The front casting 36 has apertures 184 for accepting bolts 38 that thread into the existing water pump threaded apertures in the head of the small block engine. The rear casting 158 has two apertures 186 for accepting bolts 38 that similarly thread into existing threaded apertures in the head of the small block engine. The front casting 36 and the rear casting 158 are welded to the support bar 160 at the front step 154 and back step 156. The intake manifold casting 80 has apertures 188 (see FIG. 3) for accepting bolts 38 that thread into threaded apertures 190 in the support bars 160. As shown in FIG. 3, the exhaust manifold panel castings 100 have apertures 190 for accepting bolts 38 that thread into existing threaded apertures in the head of the small block engine.

With reference to FIGS. 1 and 3, the distributor 200 (which is a non-functioning distributor) is attached to the distributor mounting plate 16 with bolts 38 that are threaded into the two apertures 18 in the distributor mounting plate 16 (see above for the design used for the tubular distributor mount for use with an operational distributor for a small block engine). The timing cover casting 12 is affixed to the front casting 36 with bolts 38 that are threaded into the five apertures 24 in the timing cover casting 12. Similarly, the water pumps 50 are attached to the front casting with bolts 38 that are threaded into threaded apertures 206 in the front casting. The exhaust manifolds 210 are attached to the exhaust manifold panel castings 100 with the bolts 38 that extend through the apertures 190 in the exhaust manifold panel castings 100.

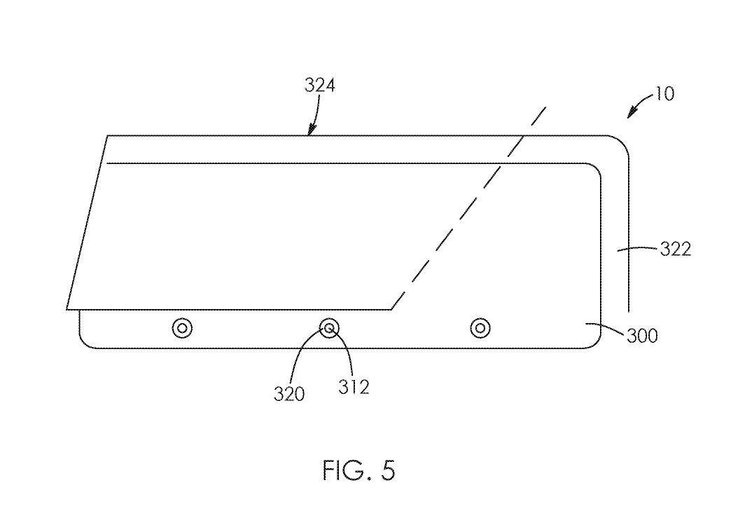

As shown in FIGS. 5, the shroud 10 covers over most of the existing engine, generally referred to as 300. The functional spark plugs 312 can be seen below the shroud 10 in the spark plug sockets 320. The shroud has an interior space, generally referred to as 322 and an exterior, generally referred to as 324.

For the stock small block engine there is a single water pump, one water (coolant) line between the pump and radiator and one coolant line between the thermostat housing and the radiator. As shown in FIG. 6, the flathead engine has two water pumps 50 and two coolant lines 326 from the heads to the radiator 354.

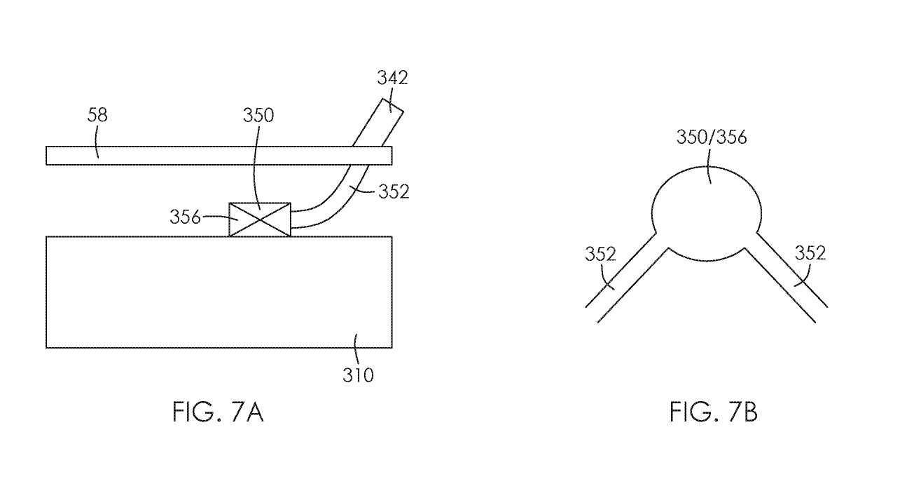

A shown in FIG. 7A and B, a split diverter valve 350 with an integrated thermostat 356 is in fluid communication with two water intake lines 352 that are in fluid communication with water intakes 342. The water intakes 342 are located on each valve cover casting 58 as in the original flatheads. For the 1932-48 style heads, the water intake is centred in the valve cover casting 58 and is front mounted for the 1949-53 style heads. The block 310 of the stock engine 300 is covered by the intake manifold casting 80, which conceals the split diverter valve 350 and water intake lines 352.

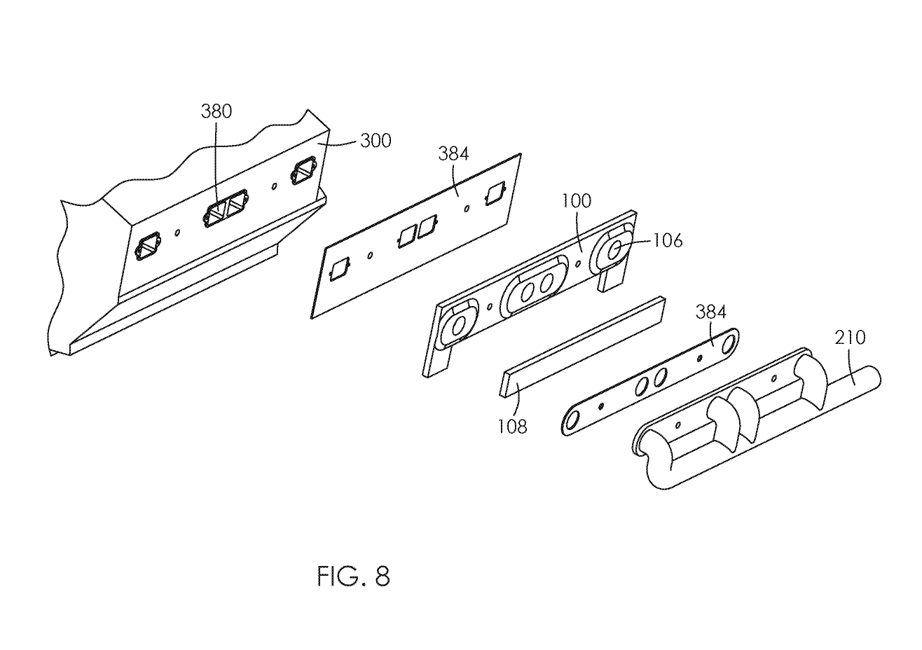

As shown in FIG. 8, exhaust gases are vented through the exhaust ports 380 of the small block engine through the exhaust manifold panel casting 100 and to the exhaust manifold 210, which may be a four pipe exhaust manifold. A gasket 384 is therefore needed between the small block engine 300 and the exhaust manifold panel casting 100 and between the exhaust manifold panel casting 100 and the exhaust manifold 210.

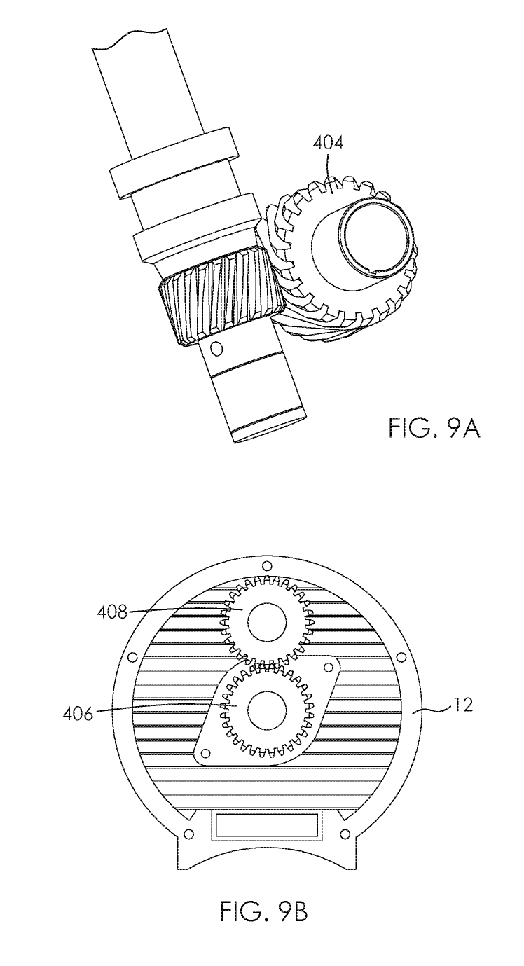

In an alternative embodiment, shown in FIG. 9a, a functional distributor 400 is relocated from its position in the small block engine to the front of the engine with a block off assembly 402 that includes a helical gear drive 404 that is connected to the front of the camshaft. This allows for a gear driven connection into the front of the camshaft via the helical gear drive 404. The design is suitable for the 1949 to 1953 engines, however the 1932 to 1948 style motors involves two gears that drive the front mount distributor. This is shown in FIG. 9b. A first gear 406 is rotationally mounted to the distributor 400 and the other, second gear 408, which is in geared relation with the first gear 406 is rotationally mounted on the cam shaft. The distributor 400 is reconfigured to function as a reverse rotation distributor.

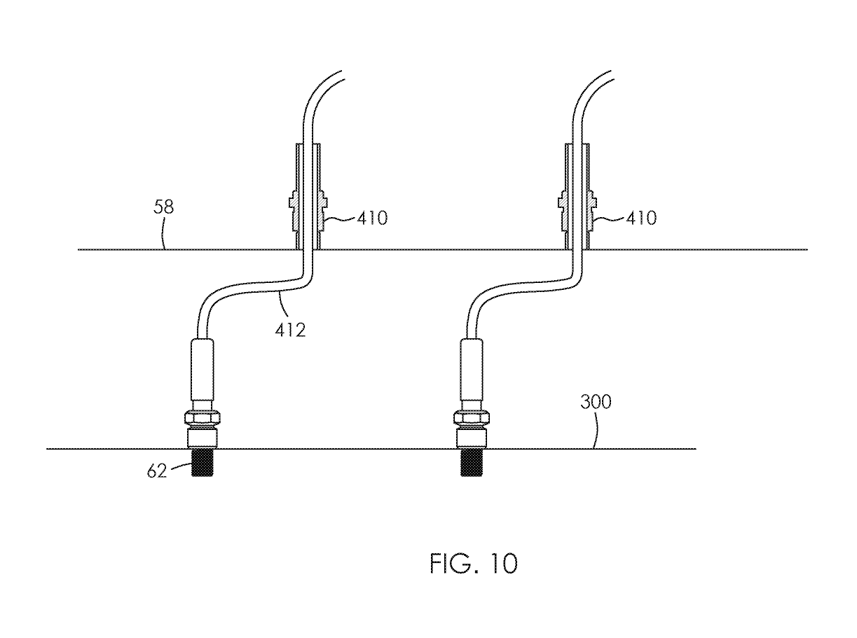

As shown in FIG. 10, a set of faux spark plugs 410 is located on the valve cover castings 58. Spark plug leads 412 route through the faux spark plugs 410 and continue between the original cylinder heads and the valve cover castings 58 through to hidden functioning spark plugs 62. These spark plugs 62 are hidden behind the valve cover castings 58 and are accessed through a removable cover 414.

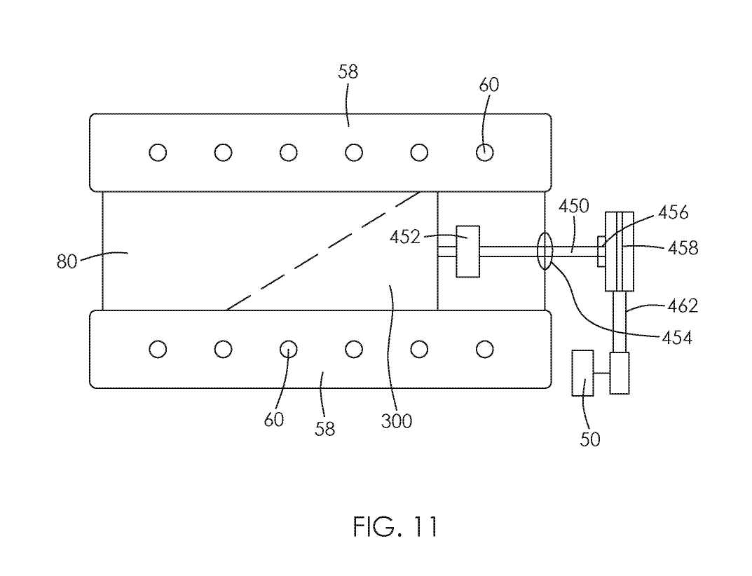

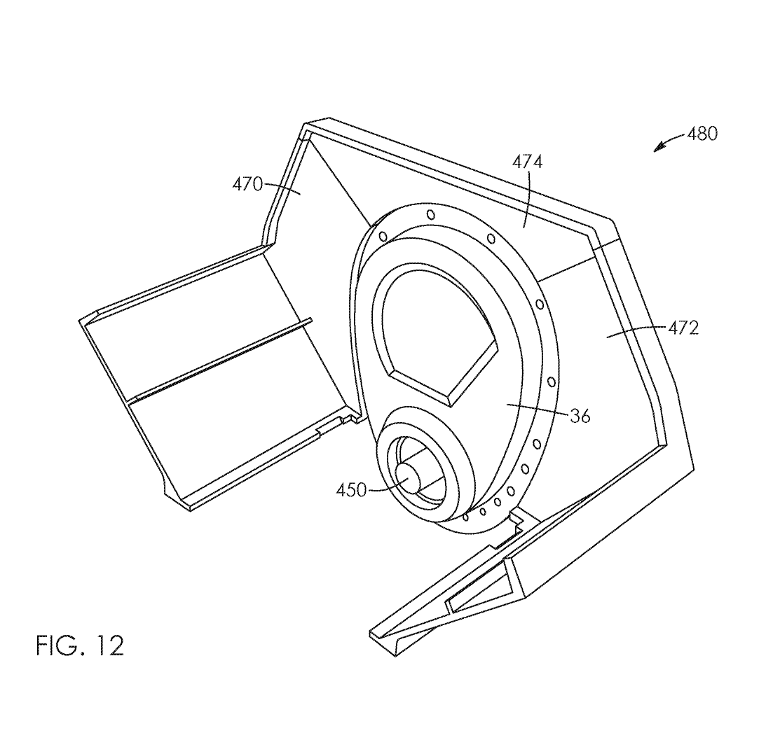

In another embodiment shown in FIG. 11, the shroud 10 is designed to look like a V12 or V16 engine. This requires that left and right valve cover castings 58, the intake manifold casting 80, the support bars 160 and the exhaust manifold panel castings 100 are all extended in length to give the illusion of a larger engine. A distributor 200 (which is a non-functioning distributor) is attached to the distributor mounting plate 16 with bolts 38 that are threaded into the two apertures 18 in the distributor mounting plate 16. The appropriate number of non-operational spark plug leads 412 feed the non-operational spark plugs 410. As shown in FIG. 11, to drive the front water pumps 50, a shaft 450 is mounted to the front of a harmonic balancer 452 going to a bearing 454 and a pulley 456 that runs the dual water pumps 50. The shaft 450 extends from the front of the stock engine about 8 inches for a V-12 and about 15 inches for a V-16, where it terminates in a second pulley 458. A belt 460 between the water pumps 50 and second pulley 458 drive the water pumps. As shown in FIG. 12, the lower sides of the shaft 450 and pulley 458 are covered with a lower left front casting 470, a lower right front casting 472 and a centre casting 474. These casting as welded to one another to form a front lower cover, generally referred to as 480. It attaches to the front casting 36.

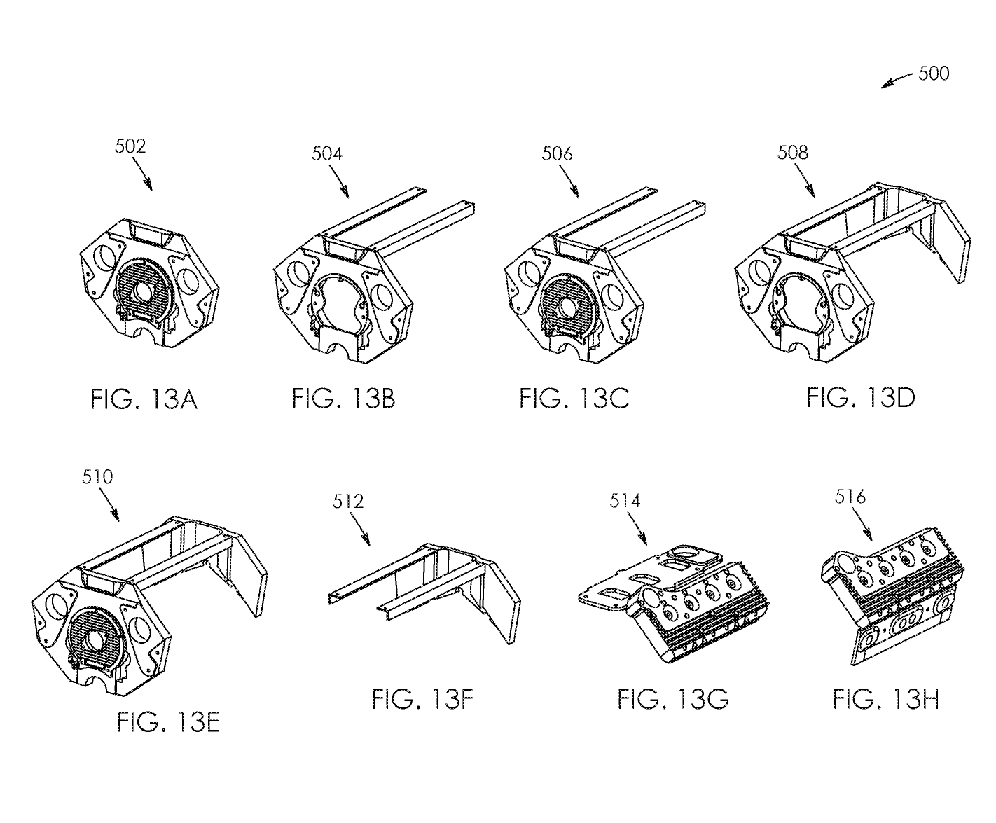

In another embodiment, as shown in FIG. 13A-H, there is a plurality of components, generally referred to as 500, that make up the shroud. There may be: eight castings and two support bars, as disclosed above; the front casting and the timing cover casting may be a single component 502 to give nine components; the front casting and the support bars may be a single component 504, for a total of eight components, or seven components if the timing cover casting and the front casting are also a single component 506; further, the rear casting, front casting and support bars may be a single component 508 for a total of seven components, or six components if the timing cover casting and the front casting are also a single component 510. The rear casting and the support bars may be a single component 512. The valve cover castings and intake manifold casting may be a single component 514. Each valve cover casting and exhaust manifold panel casting pair may be a single component 516. The support bars may or may not be included in the plurality of components.

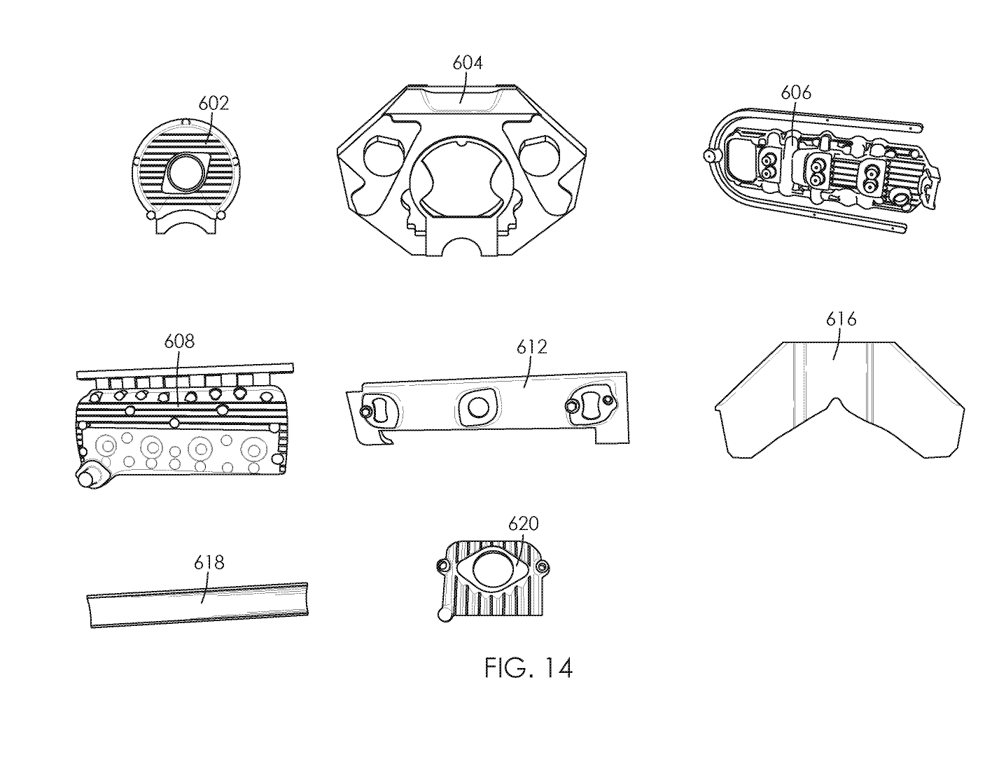

The templates used to form the molds used to cast the parts for a V8 shroud are shown in FIG. 14. There is one for a timing cover mold 602, a front mold 604, an intake manifold mold 606, a right valve cover mold 608, a left valve cover mold, a right exhaust manifold panel mold 612, a left exhaust manifold panel mold, a rear mold 616 and a spark plug cover mold 618. There is also an intake manifold cover template 620. The templates for left molds are simply the mirror image of the templates for the right molds. The molds are sand and are filled with molten aluminum in the manufacture of the castings.

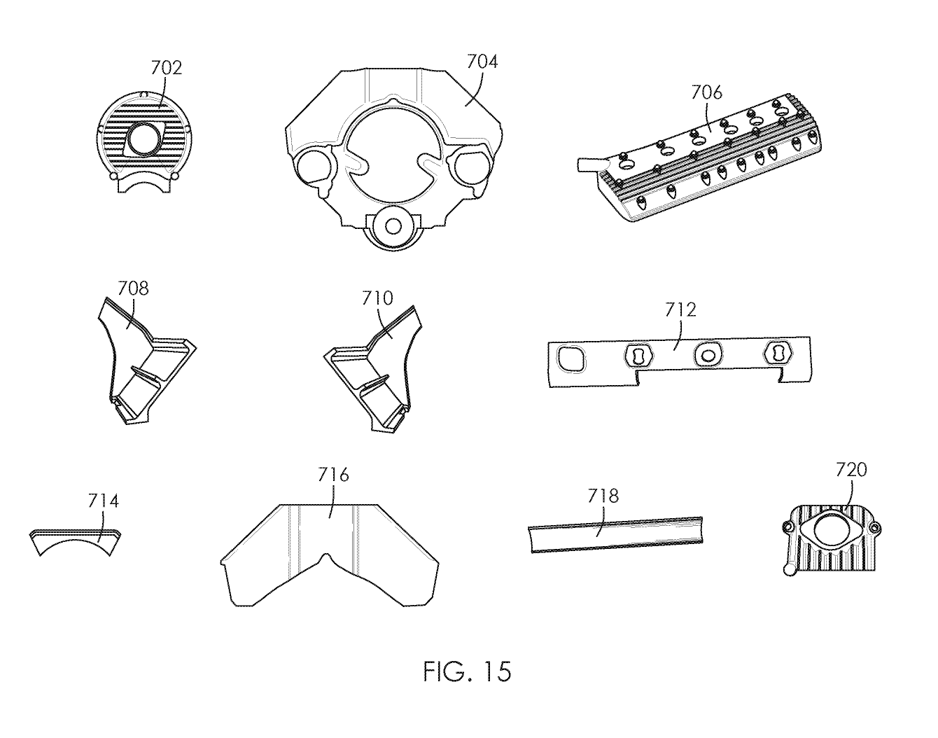

The templates used to form the molds used to cast the parts for a V12 shroud are shown in FIG. 15. There is one for a timing cover mold 702, a front mold 704, a right valve cover mold, a left valve cover mold 706, a lower right front mold 708, a lower left front mold 710, a right exhaust manifold panel mold 712, a left exhaust manifold panel mold, a centre mold 714, a rear mold 716 and a spark plug cover mold 718. There is also an intake manifold cover template 720. The templates for the left molds are simply the mirror image of the templates for right molds. The templates for the valve cover molds and exhaust manifold panel molds are essentially the same as those for the V8, but for a V12 engine. The molds are sand and are filled with molten aluminum in the manufacture of the castings.

In yet another embodiment, the stock engine could be a large block engine and the faux engine a flathead engine. Other non-limiting examples of stock engines include an overhead valve V-6 or V-8 engine or a big block overhead valve V-8.

In still yet another embodiment, the stock engine is a V-8 overhead valve engine and the faux engine is a V-12 or V-16 engine. The exhaust manifold panel casting is designed for a three pipe exhaust manifold for the V-8, four for the V-12 and five for the V-16. Still further, it is considered that a multi-casting shroud can be designed to substantially cover a stock engine to give it the appearance of a different engine, the caveat being that the stock engine is smaller than the faux engine. Non-limiting examples of stock engines include an overhead valve V-6 or V-8 engine or a big block overhead valve V-8.

1. A faux engine, the faux engine comprising a stock engine and a shroud for the stock engine, wherein the shroud comprises a plurality of components assembled to provide an interior space to house the stock engine, is attached to the stock engine, and is configured to substantially conceal the stock engine and mimic an exterior of a different engine.

2. The faux engine of claim 1, wherein the different engine is a flathead engine.

3. The faux engine of claim 2, wherein the shroud is configured to expose a plurality of spark plug sockets on the stock engine, a bottom of the stock engine and a bell housing of the stock engine and to conceal a remainder of the stock engine.

4. The faux engine of claim 3, further comprising a plurality of non-operational spark plugs mounted on a valve cover portion of the shroud, a non-operational distributor mounted on a front portion of the shroud and a plurality of non-operational spark plug leads extending therebetween.

5. The faux engine of claim 4, further comprising a plurality of operational spark plugs located in the spark plug sockets, a distributor-less ignition and a plurality of operational spark plug leads therebetween.

6. The faux engine of claim 5, wherein the plurality of operational spark plug leads is routed between the shroud and the stock engine.

7. The faux engine of claim 6, further comprising a pair of operational water pumps mounted on and in fluid communication with a front portion of the shroud.

8. The faux engine of claim 7, wherein the stock engine is a small block engine.

9. A flathead shroud for a stock engine, the flathead shroud comprising a plurality of components assembled to provide an interior space, the interior space for housing a stock engine, and an exterior, the exterior configured to mimic an exterior of a flathead engine, and to substantially conceal the stock engine.

10. The flathead shroud of claim 9, wherein the plurality of components includes: an intake manifold casting; a pair of valve cover castings; a rear casting; a pair of exhaust manifold panel castings; and one of either a front casting and a timing cover casting or an integrated timing cover and front casting, the components assembled such that the intake manifold casting is atop the pair of valve cover castings, the pair of exhaust manifold panel castings are below the pair of valve cover castings, the front casting and timing cover casting or the integrated timing cover and front casting abut a front of each of the intake manifold casting, the pair of valve cover castings and the pair of exhaust manifold panel castings, the timing cover casting, if present, is in front of the front casting and the rear casting abuts a rear of each of the intake manifold casting, the pair of valve cover castings and the pair of exhaust manifold panel castings.

11. The flathead shroud of claim 10 wherein the interior space is sized to additionally house a plurality of spark plug leads, an at least one water hose, and a split diverter.

12. The flathead shroud of claim 11, wherein the intake manifold casting includes an at least one mount for an at least one carburetor and an at least one carburetor port for gaseous communication with the at least one carburetor.

13. The flathead shroud of claim 12 wherein the pair of valve cover castings include a plurality of non-operational spark plug sockets.

14. The flathead shroud of claim 13, wherein the pair of valve cover castings include a plurality of non-operational spark plug sockets.

15. The flathead shroud of claim 14, comprising the front casting and the timing cover casting.

16. The flathead shroud of claim 15, wherein the timing cover casting includes a mounting plate for a distributor.

17. The flathead shroud of claim 16, wherein the front casting includes a pair of mounting plates for a pair of water pumps and a channel through the front casing for liquid communication with the pair of water pumps.

18. The flathead shroud of claim 17, wherein the intake manifold casting includes an at least one mount for an at least one carburetor and an at least one carburetor port for gaseous communication with the at least one carburetor.

19. A kit for shrouding a small block engine to make it appear as a flathead engine, the kit comprising a timing cover casting, a front casting, a pair of exhaust manifold panel castings, a pair of valve cover castings, an intake manifold casting, a rear casting, and instructions.

20. The kit of claim 19, wherein the pair of valve cover castings include a plurality of non-operational spark plug sockets.
